(19) United States
(12) Patent Application Publication
(10) Pub. No.: US 2004/0081299 A1
(43) Pub. Date: Apr. 29, 2004

(54) System and method for select messaging

(75) Inventor: Russell William White, Austin, TX (US)

Correspondence Address: William A. Webb, BRINKS HOFER GILSON & LIONE, P.O. Box 10395, Chicago, IL, 60610, US

(73) Assignee: SBC PROPERTIES, L.P.

(21) Appl. No.: 10/280,325

(22) Filed: Oct. 24, 2002

(51) Int. Cl. H04M 11/00

(52) U.S. Cl. 379/93.09

(57) ABSTRACT

A telephone terminal comprises an analog telephone line interface, a dial-up modem to communicate data via the analog telephone line interface, and an audio input/output interface to facilitate voice calls via the analog telephone line interface. A data connection is made via the analog telephone line interface using the dial-up modem. The telephone terminal itself detects that an outgoing voice call is to be placed, and in response thereto, places the dial-up modem in an on-hold state and suspends the data connection.

### BACKGROUND OF THE INVENTION

1. Field of the Invention

The present invention relates to wireline telephones that provide messaging features.

2. Description of the Related Art

Some individuals desire or subscribe to an Internet service provider (ISP) (e.g. AOL or MSN) as a means to provide them e-mail and/or managed browsing, but little else. At home, some ISP subscribers access their e-mail using a personal computer (PC) having an e-mail client program (e.g. Microsoft Outlook™) and/or a browser program (e.g. Microsoft Internet Explorer™ or Netscape Communicator™)

Other ISP subscribers access their e-mail using an Internet appliance. In the United States, use of Internet appliances is dwarfed by use of PCs to access ISPs. The marketing of Internet appliances as stripped-down computers may have contributed to their lack of popularity. This is because some consumers find it hard to justify paying very much for a stripped-down computer.

Many subscribers access their ISP via their analog telephone line using a dial-up modem. V.92 is a new dial-up modem specification having features that address issues when the same analog telephone line is used for both voice calls and Internet data connections. Using the V.92 standard, an in-progress data connection with the ISP can be suspended so that a voice call can be received if the user has enabled a call-waiting feature with their local telephone company. With call waiting services, the telephone company sends a beep to the user to indicate a waiting telephone call. A V.92 modem may respond to the beep by executing a modem-on-hold applet supplied with a modem driver. The applet puts the V.92 modem in an on-hold state. Thereafter, the call waiting telephone call may be forwarded to the user.

### BRIEF DESCRIPTION OF THE DRAWINGS

The present invention is pointed out with particularity in the appended claims. However, other features are described in the following detailed description in conjunction with the accompanying drawings in which:

FIG. 1 is a schematic block diagram of an embodiment of a system to provide select messaging services;

FIG. 2 is a block diagram of an embodiment of a telephone terminal having a smart data connection feature;

FIG. 3 is an illustration depicting features in an embodiment of the telephone terminal;

FIG. 4 is flow chart of an embodiment of a method of providing the personal operator service; and

FIG. 5 is schematic diagram of an alternative embodiment of a system to provide select messaging services.

### DETAILED DESCRIPTION OF THE PREFERRED EMBODIMENTS

Disclosed herein are embodiments of a telephone terminal and associated services that converge various communication types (including but not limited to telephone calls, e-mails, and voice mails) into a single device that is, at its core, a telephone and not a general-purpose PC. The telephone terminal comprises a dial-up modem, such as a V.92 modem, that enables a data connection to be made via an analog telephone line. Beneficially, the telephone terminal itself has a smart data connection feature. Here, the telephone terminal itself detects when an outgoing voice call is to be placed, and in response thereto, places its dial-up modem in an on-hold state and suspends the data connection. Thus, a user need not enter a command into a general-purpose PC to suspend the data connection to place outgoing voice calls using the telephone terminal.

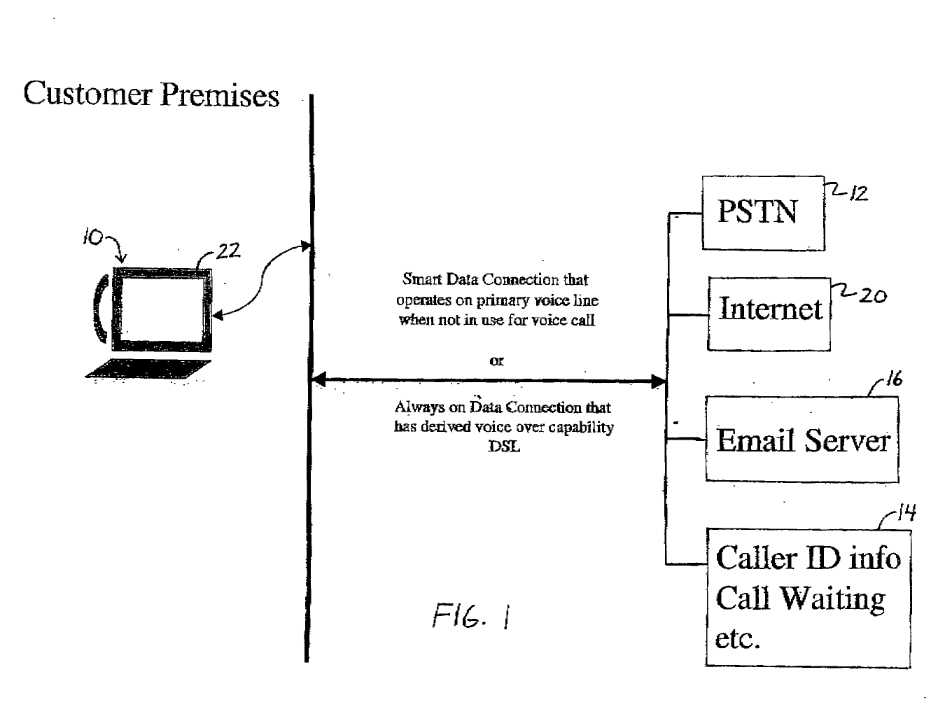

FIG. 1 is a schematic block diagram of an embodiment of a system to provide select messaging services. The system comprises a telephone terminal 10 that, preferably, has the aforementioned smart data connection feature. In this case, the telephone terminal 10 operates in a data connection mode on a primary voice line when not in use for a voice call. Alternatively, the telephone terminal 10 has an always-on data connection via a digital subscriber line (DSL). In this case, the telephone terminal 10 has a derived voice capability over DSL so voice calls become packet calls.

The telephone terminal 10 offers a convenient interface to a public switched telephone network (PSTN) 12. Incoming and outgoing calls can be made using the telephone terminal 10. Further, the telephone terminal 10 provides an interface to an increasing number of phone-based services 14 such as Caller ID and Call Waiting.

Still further, the telephone terminal 10 provides access to an e-mail server 16, or more preferably, a unified messaging server. The unified messaging server provides access to various types of messages, including but not limited to, voice messages, e-mail messages, and faxes. Yet still further, the telephone terminal 10 can be used to access and browse the Internet 20 or another computer network.

The telephone terminal 10 may sense line inactivity and log on to refresh a unified messaging in-box, and or to cache any Web-site content of interest to the user. As a result, checking e-mail is much simpler and faster for the user. The user's in-box is automatically updated and displayed on a visual display 22 of the telephone terminal 10.

The telephone terminal 10 is a feature-rich telephone, and in preferred embodiments, does not boot-up like a personal computer. The telephone terminal 10 can give consumers a way to get e-mail without the hassle and expense of a general purpose personal computer. Both computer novices and experts would appreciate the convenience of checking e-mail without repeatedly booting up their PC and logging into an ISP.

Ideally, the telephone terminal 10 has a compact design for placement in a kitchen, a den, or other rooms in the home. The telephone terminal 10 may wire directly to an RJ-11 jack, for example, in the home.

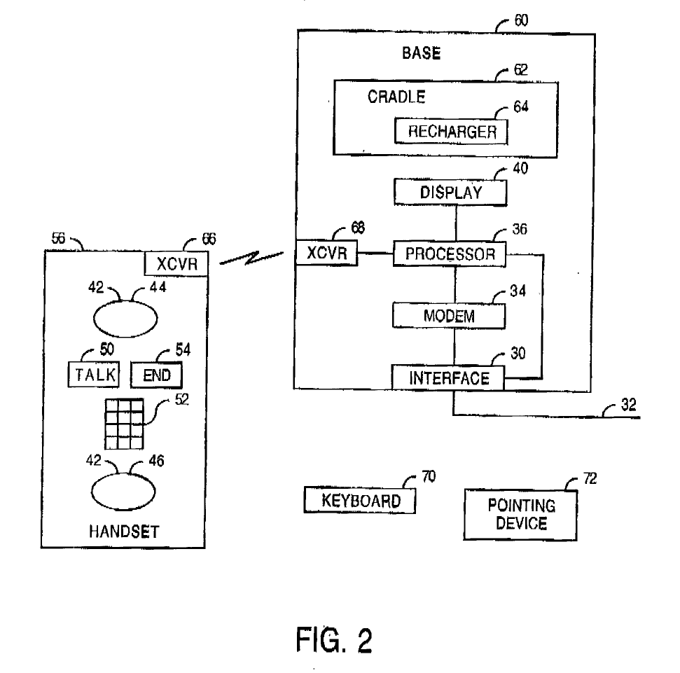

FIG. 2 is a block diagram of an embodiment of the telephone terminal 10 having a smart data connection feature. The telephone terminal comprises an analog telephone line interface 30 that facilitates a connection to an analog telephone line 32. The analog telephone line interface 30 may comprise a standard telephone line jack such as an RJ-11 jack. The analog telephone line 32 may comprise a plain-old telephone service (POTS) line.

The telephone terminal comprises a dial-up modem 34 to make data connections and to communicate data via the analog telephone line interface 30. The dial-up modem 34 operates on a standard that provides a modem-on-hold function. Preferably, the standard is based on a V.92 standard. Using V.92, the dial-up modem 34 also enables a quick connect feature and a PCM upstream feature.

Information received by the dial-up modem 34 is processed by a processor 36 and displayed by a visual display 40. In one embodiment, the visual display 40 comprises a liquid crystal display capable of displaying textual and graphical information.

The telephone terminal further comprises an audio input/output interface 42 to facilitate voice calls via the analog telephone line interface 30. The audio input/output interface 42 comprises an audio output device 44 such as a speaker and an audio input device 46 such as a microphone.

The telephone terminal comprises standard controls to assist users in placing outgoing voice calls and answering incoming voice calls. A first control 50 enables users to place the telephone terminal in an off-hook condition to answer an incoming voice call, or to prepare the telephone terminal to place an outgoing voice call. The first control 50 is commonly embodied by a button labeled as a “talk” button, a “phone” button, an “on” button, or an “off-hook” button. Other embodiments of the first control 50 are also within the scope of this disclosure. A telephone keypad 52 enables users to dial a telephone number to place outgoing voice calls. A second control 54 enables users to place the telephone terminal in an on-hook condition to terminate either an incoming voice call or an outgoing voice call. The second control 54 is commonly embodied by a button labeled as a “end” button, an “off” button, or an “on-hook” button. Other embodiments of the second control 54 are also within the scope of this disclosure.

Preferably, the telephone terminal comprises a handset 56 and a base 60. The handset 56 supports the audio input/output interface 44, the telephone keypad 52, and the first and second controls 50 and 54. The base 60 supports the analog telephone line interface 30, the dial-up modem 34, the processor 36, and the visual display 40. The base 60 may comprise a cradle 62 to support the handset 56. Optionally, the base 60 includes a recharger 64 to recharge a power source of the handset 56 when the handset 56 rests in the cradle 62.

The handset 56 communicates with the base 60 either wirelessly or via a wireline. For wireless communication, the handset 56 comprises a wireless transceiver 66 to communicate with a wireless transceiver 68 of the base 60. Examples of wireless standards for communication between the handset 56 and base 60 include, but are not limited to, a 900 MHz cordless telephone standard, a 2.4 GHz wireless standard, a Bluetooth standard, and a wireless local area network (LAN) standard such as 802.11a or 802.11b. Preferably, wireless communication between the handset 56 and the base 60 is encrypted.

Preferably, in the absence of any incoming or outgoing voice calls, the processor 36 directs the dial-up modem 34 to provide a substantially always-on data connection to a service provider via the analog telephone line interface 30. Thus, the dial-up modem 34 automatically dials the service provider to make the data connection. The data connection can be made using the quick connect feature of V.92.

The service provider provides a unified messaging node that provides information such as e-mail information, voice-mail information, local weather information, and personal schedule information. The dial-up modem 34 receives the information from the service provider. The processor 36 processes the information for display by the visual display 40. Users may interact with nodes (e.g. the unified messaging node and other nodes such as Web sites) accessible via the service provider by an alphanumeric keyboard 70 and a pointing device 72. Examples of the pointing device 72 include, but are not limited to, a mouse, a trackball, a trackpad, a pointing stick and a joystick. The keyboard 70 and the pointing device 72 may communicate wirelessly or via a wireline to the base 60. For example, the keyboard 70 may communicate with the base 60 using any of the herein-disclosed wireless standards such as a Bluetooth standard.

The data connection is suspended when the analog telephone line 32 is used for incoming and outgoing voice calls. For incoming voice calls, the processor 36 places the dial-up modem 34 in a modem-on-hold state. Thereafter, users can answer incoming voice calls by selecting the first control 50. Alternatively, users can answer incoming voice calls by removing the handset 56 from the cradle 62.

To enable communication between the user and a calling party in the voice call, the processor 36 couples the wireless transceiver 68 to the analog telephone line interface 30. Thus, audio signals are communicated between the audio input/output interface 42 and the analog telephone line interface 30 via the wireless link between the wireless transceivers 66 and 68.

To terminate incoming voice calls, the user selects the second control 54. In response to the selection of the second control 54 or otherwise using the telephone terminal itself to detect that an incoming call is complete, the processor 36 uncouples the wireless transceiver 66 from the analog telephone line interface 30, and directs the dial-up modem 34 to return to the data connection with the service provider. The data connection may be returned using the quick connect feature of V.92.

For outgoing voice calls, the telephone terminal itself detects if an outgoing voice call is to be placed. For example, the telephone terminal may detect that an outgoing voice call is to be placed by detecting a user selection of the first control 50. Alternatively, the telephone terminal may detect that an outgoing voice call is to be placed by detecting that the handset 56 has been removed from the cradle 62 of the base 60.

In response to the telephone terminal detecting that the outgoing voice call is to be placed, the processor 36 places the dial-up modem 34 in a modem-on-hold state. To enable the user to dial another party, the processor 36 couples the wireless transceiver 68 to the analog telephone line interface 30. The user is presented a dial tone from the analog telephone line 32 via the audio output device 44, and can dial the party using the telephone keypad 52. Audio signals in the outgoing call are communicated between the audio input/output interface 42 and the analog telephone line interface 30 via the wireless link between the wireless transceivers 66 and 68.

To terminate outgoing voice calls, the user selects the second control 54. In response to the selection of the second control 54 or otherwise using the telephone terminal itself to detect that an outgoing voice call is complete, the processor 36 uncouples the wireless transceiver 66 from the analog telephone line interface 30, and directs the dial-up modem 34 to return to the data connection with the service provider. The data connection may be returned using the quick connect feature of V.92.

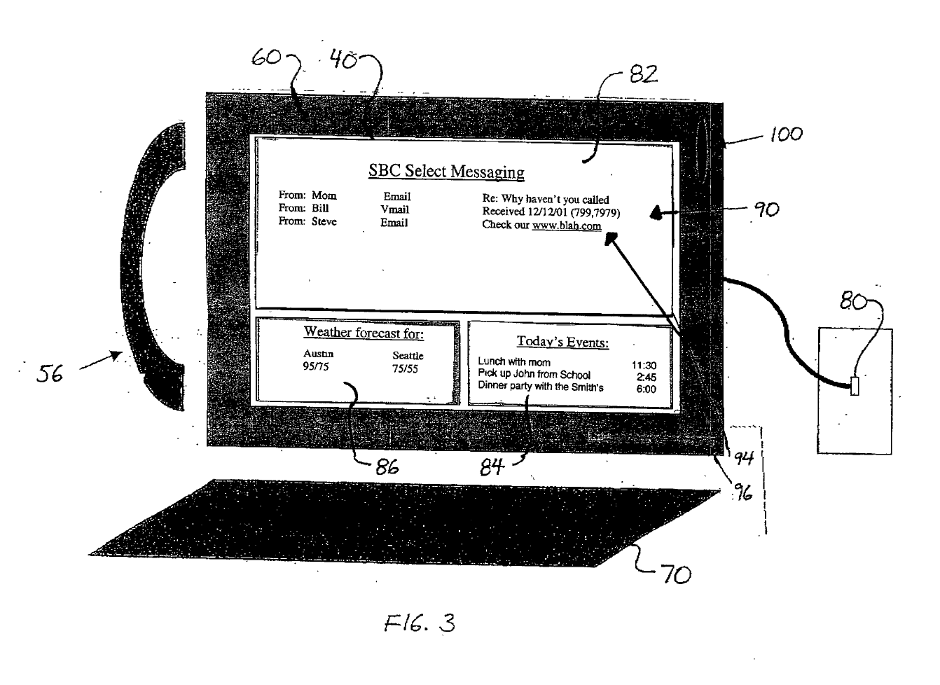

FIG. 3 is an illustration depicting features in an embodiment of the telephone terminal 10. Shown in FIG. 3 is an embodiment of the handset 56, the base 60 having the visual display 40 integrated therewith, and the keyboard 70. The base 60 is wired to an RJ-11 wall jack 80 which provides access to the analog telephone line 12.

The telephone terminal provides the user with a vehicle that supports a unified messaging mailbox 82 as well as add-on features such as a personal calendar/schedule service to provide personal schedule information 84 and a weather reporting service to provide weather information 86. The telephone terminal may also support wireline short messaging service (SMS) messaging.

The unified messaging mailbox 82 displays both voice mail messages and e-mail messages. An incoming voice message may include a user-selectable link 90 for adding information associated therewith to an address book. An incoming e-mail message may include a user-selectable link 94 having a computer address such as a URL to a Web site. The telephone terminal may include a memory 96 to store a cached-version of the Web site.

The telephone terminal may include an indicator 100 to let users visually determine whether or not the device is on-line. In this case, the indicator 100 provides a first signal if a data connection exists with the ISP, and a second signal in the absence of a data connection.

Optionally, in the absence of a supply of power for the telephone terminal, the telephone terminal reverts to a POTS telephone. In this case, no data connection exists with the ISP, but the telephone terminal still is capable of functioning to receive incoming voice calls and to place outgoing voice calls.

The telephone terminal may be used to access a personal operator service. Using the personal operator service, a user can dial a trigger such as “#0” or “*0” to listen to a virtual secretary, and request an action such as call mom, send e-mail, or remind me of a 3:00 appointment, for example.

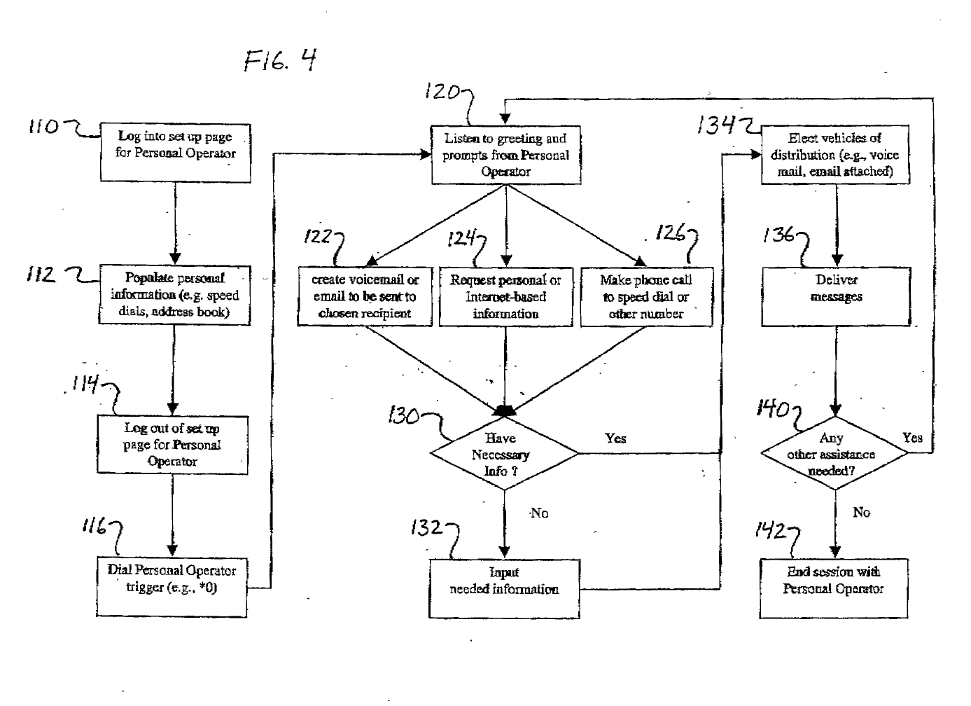

FIG. 4 is flow chart of an embodiment of a method of providing the personal operator service. As indicated by block 110, a user can log into a set-up page for the personal operator service. The set-up page is displayed when the telephone terminal has a data connection with the ISP. As indicated by block 112, the personal operator service receives personal information from the user via the set-up page, and populates a database based thereon. Examples of the personal information include, but are not limited to, speed dial numbers and an address book. The information can be entered using the keyboard 70 and/or the pointing device 72. As indicated by block 114, the user can log out of the set-up page after providing the personal information.

As indicated by block 116, the user can access the personal operator service in a voice call by dialing a trigger (e.g. “#0” or “*0”). As indicated by block 120, the personal operator service provides an audible voice greeting and prompts for a plurality of options. Examples of the options include, but are not limited to, creating a voice mail or an e-mail to be sent to a specific recipient (block 122), requesting personal or Internet-based information (block 124), and making a phone call to a speed dial number or another number (block 126). The user selects one or more of the options.

The personal operator service determines whether or not it has all of the necessary personal information to perform the selected option (block 130). If more information is needed, the personal operator service prompts the user to input the additional information (block 132).

As indicated by block 134, the personal operator service allows the user to select one or more vehicles of distribution. Examples of the vehicles include, but are not limited to, a voice mail message and an e-mail message. Based on the selected vehicle(s), the personal operator service delivers one or more messages (block 136).

As indicated by block 140, the personal operator service allows the user to return to an previous menu of options if further assistance is needed. Otherwise, the user can end the session with the personal operator (block 142).

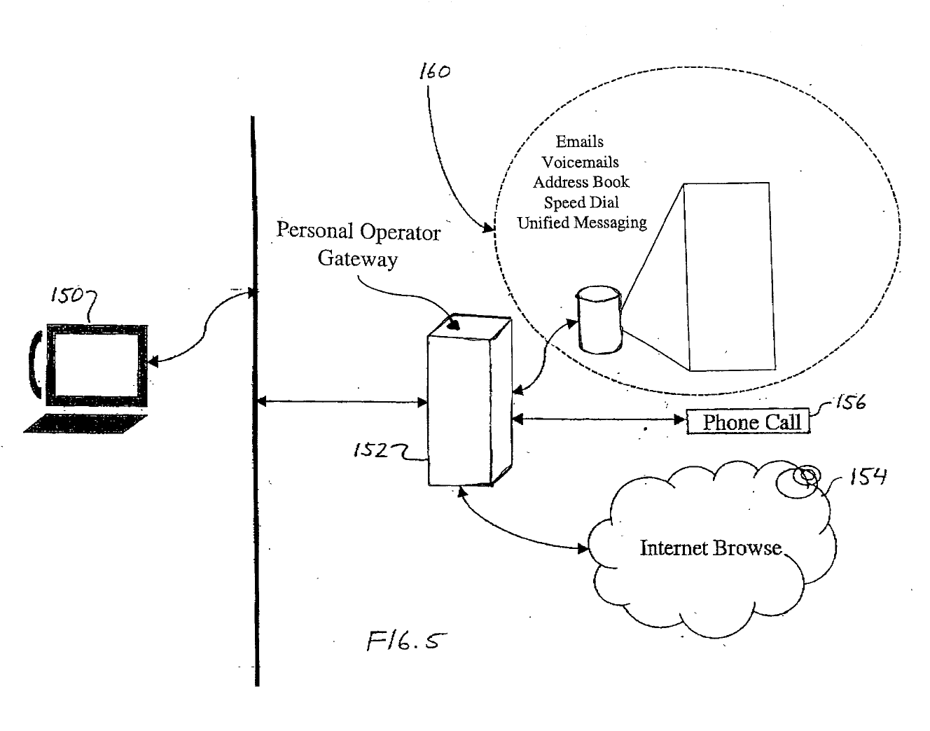

FIG. 5 is schematic diagram of an alternative embodiment of a system to provide select messaging services. In this embodiment, a telephone terminal 150 has an always-on data connection via a digital subscriber line (DSL). Absent the smart data connection features described herein, the telephone terminal 150 has other features of the herein-disclosed telephone terminals.

The telephone terminal 150 accesses a personal operator gateway 152 via the DSL network. The personal operator gateway 152 provides access to the Internet 154 so that users can browse the Internet 154 using the telephone terminal 150. The personal operator gateway 152 also allows the user to make voice calls. The telephone terminal 150 has a derived voice capability over DSL so that voice calls become packet calls to the personal operator gateway 152. The personal operator gateway 152 may direct the calls to a PSTN. The personal operator gateway 152 also provides the unified messaging and personal operator services 160 described herein.

Preferably, in the absence of a supply of power for the telephone terminal 150, the telephone terminal 150 reverts to a POTS telephone. In this case, the telephone terminal 150 no longer converts voice calls into packet calls, but provides a capability to receive incoming analog voice calls and to place outgoing analog voice calls.

Thus, there have been disclosed herein several embodiments including preferred embodiments of a select messaging method and system.

It will be apparent to those skilled in the art that the disclosed inventions may be modified in numerous ways and may assume many embodiments other than the preferred forms specifically set out and described herein.

Accordingly, it is intended by the appended claims to cover all modifications which fall within the true spirit and scope of the present invention.

What is claimed is:

1. A method comprising:
providing a telephone terminal which comprises an analog telephone line interface, a dial-up modem to communicate data via the analog telephone line interface, and an audio input/output interface to facilitate voice calls via the analog telephone line interface;
making a data connection via the analog telephone line interface using the dial-up modem;
detecting, by the telephone terminal, that an outgoing voice call is to be placed using the telephone terminal; and
placing the dial-up modem in an on-hold state and suspending the data connection in response to said detecting that the outgoing voice call is to be placed.

2. The method of claim 1 wherein the dial-up modem operates based on a V.92 standard.

3. The method of claim 1 wherein the telephone terminal further comprises a control to enable the voice call, and wherein said detecting that the outgoing voice call is to be placed comprises detecting a user selection of the control.

4. The method of claim 3 wherein the control is selected from the group consisting of a talk button, a phone button, an on button, and an off-hook button.

5. The method of claim 3 wherein the telephone terminal further comprises a handset which supports the audio input/output interface and the control, and a base which supports the analog telephone line interface.

6. The method of claim 5 wherein the handset wirelessly communicates with the base.

7. The method of claim 6 wherein the handset communicates with the base according to a Bluetooth standard.

8. The method of claim 6 wherein the handset communicates with the base according to a wireless local area network (LAN) standard.

9. The method of claim 8 wherein the wireless LAN standard comprises an 802.11 standard.

10. The method of claim 5 wherein said detecting that the outgoing voice call is to be placed comprises detecting that the handset has been removed from a cradle of the base.

11. The method of claim 1 further comprising:
detecting by the telephone terminal that the outgoing voice call is complete; and
returning to the data connection in response to said detecting that the outgoing call is complete.

12. The method of claim 11 wherein the data connection is substantially always-on in time intervals absent any outgoing or incoming voice calls made using the telephone terminal.

13. The method of claim 11 wherein the data connection is to a unified messaging node.

14. The method of claim 13 wherein the telephone terminal further comprises a visual display to display information from the unified messaging node.

15. The method of claim 14 wherein the information comprises e-mail and voice-mail messages, weather information, and personal schedule information.

16. A telephone terminal comprising:
an analog telephone line interface;
a dial-up modem to communicate data via the analog telephone line interface;
an audio input/output interface to facilitate voice calls via the analog telephone line interface; and
a processor to direct the dial-up modem to make a data connection via the analog telephone line interface, and to place the dial-up modem in an on-hold state and suspend the data connection in response to detecting that an outgoing voice call is to be placed.

17. The telephone terminal of claim 16 wherein the dial-up modem operates based on a V.92 standard.

18. The telephone terminal of claim 16 further comprising:
a control to enable the voice call;
wherein processor is to detect that the outgoing voice call is to be placed by detecting a user selection of the control.

19. The telephone terminal of claim 18 wherein the control is selected from the group consisting of a talk button, a phone button, an on button, and an off-hook button.

20. The telephone terminal of claim 18 further comprising:
a handset which supports the audio input/output interface and the control; and
a base which supports the analog telephone line interface.

21. The telephone terminal of claim 20 wherein the handset wirelessly communicates with the base.

22. The telephone terminal of claim 21 wherein the handset communicates with the base according to a Bluetooth standard.

23. The telephone terminal of claim 21 wherein the handset communicates with the base according to a wireless local area network (LAN) standard.

24. The telephone terminal of claim 23 wherein the wireless LAN standard comprises an 802.11 standard.

25. The telephone terminal of claim 20 wherein the processor is to detect that the outgoing voice call is to be placed by detecting that the handset has been removed from a cradle of the base.

26. The telephone terminal of claim 16 wherein the processor is to direct the dial-up modem to return to the data connection in response to detecting that the outgoing call is complete.

27. The telephone terminal of claim 26 wherein the data connection is substantially always-on in time intervals absent any outgoing or incoming voice calls.

28. The telephone terminal of claim 26 wherein the data connection is to a unified messaging node.

29. The telephone terminal of claim 28 further comprising a visual display to display information from the unified messaging node.

30. The telephone terminal of claim 29 wherein the information comprises e-mail and voice-mail messages, weather information, and personal schedule information.

31. A telephone terminal comprising:
a housing component at least partially defining an interior space of a communication device;
a data modem located within the interior space, the modem operable to communicate data via a wired communication line;
a low power wireless communication module located within the interior space, the communication module operable to communicate using radio frequencies near or above 900 MHz;
a display device operable to display information associated with incoming data communicated to the communication device via the modem;
a telephone handset to make voice calls via the communication line, the telephone handset operable to wirelessly communicate with the low power communication module;
a processor engine associated with the modem and operable to direct a data connection via the communication line; and
a privacy engine operable to protect the security of communication module wireless communications.

32. The telephone terminal of claim 31 wherein the data modem operates based on a V.92 standard and the wired communication line comprises a twisted pair of copper wires.

33. The telephone terminal of claim 30, wherein the data modem operates based on a DOCSIS standard and the wired communication line comprises coax cable.

34. The telephone terminal of claim 30, wherein the telephone handset communicates with the communication module at around 2.4 GHz.

35. The telephone terminal of claim 34, wherein the telephone handset communicates with the communication module using an 802.11 standard.

36. The telephone terminal of claim 30, further comprising a browser engine operable to present a graphical user interface on the display.

37. The telephone terminal of claim 36, further comprising a messaging in box displayed within the graphical user interface, the messaging in box showing information comprising e-mail and voice-mail messages.

38. The telephone terminal of claim 37, further comprising a personal home page displayed within the graphical user interface, the personal home page comprising the messaging in box, weather information, and personal schedule information.

39. The telephone terminal of claim 30, further comprising a data modem interface and wherein the data modem is a modular data modem that can be coupled to the communication device via the data modem interface and removed from the communication device by disconnecting the data modem from the data modem interface.

40. The telephone terminal of claim 30, further comprising a telephony engine operable to initiate a derived voice data channel, the derived voice data channel for allowing packetized voice communication across the communication line.
